(19) United States
(12) Patent Application Publication
(10) Pub. No.: US 2013/0255196 A1
(43) Pub. Date: Oct. 3, 2013

(54) BALE WRAPPING APPARATUS

(71) Applicant: John Johnston, Fife (GB)

(72) Inventor: John Johnston, Fife (GB)

(73) Assignee: FRONT MACHINERY LIMITED, FIFE (GB)

(21) Appl. No.: 13/992,858

(22) PCT Filed: Dec. 8, 2011
(86) PCT No.: PCT/GB11/52428

§ 371 Date: Jun. 10, 2013

(30) Foreign Application Priority Data
Dec. 8, 2010 (GB) 1020784.3

(51) Int. Cl. A01F 15/07

(52) U.S. Cl. CPC A01F 15/071
USPC 53/465; 53/211

(57) ABSTRACT

A bale wrapping apparatus includes a bale engager to engage an end of a bale and a bale engager mover to move the bale engager between a bale engaging position in which the bale engager faces in a first direction and a bale releasing position in which the bale engager faces in a second direction such that a bale can be engaged and disengaged by the bale engager while the bale engaging apparatus is propelled in one direction.

### FIELD OF THE INVENTION

The invention relates to bale wrapping apparatus used to wrap materials such as straw and hay.

### BACKGROUND TO THE INVENTION

Bale wrapping apparatus are used by farmers to wrap bales of straw and similar such material in order to allow the storage of fodder and straw bales in the open. Round bales have net or twine wound around their periphery in order to ensure their contents remain compact during both transit and storage. Whilst some bales are stored inside during inclement weather, most straw bales are stored outside. The portion of the bale which is in contact with the ground, particularly in wet weather, will quickly degrade and rot, whilst the remainder of the periphery will also degrade to varying degrees. This results in expensive wastage both in labour and stored material as the degree of waste and its separation varies from bale to bale.

The wrapping of a complete bale using the agricultural or industrial equivalent to cling film can lead to harmful mould unless the bale is essentially dry before being enclosed. The most inexpensive way of wrapping bales is to only wrap the periphery, leaving the ends open. This allows the bale to ‘breathe’, thereby largely preventing problems with decomposition and mould.

Known bale wrapping apparatus are usually towed behind a tractor. This means that aligning the part of the apparatus that engages and lifts the bale is an operation that requires time and skill on the part of the tractor driver.

EP0 274 026 discloses a bale wrapping apparatus that is fitted to the front end of a tractor directly in ahead of the vehicle. In order to engage a cylindrical bale, the tractor is driven forwards to bring two elongate rollers that extend parallel to the axis of the bale into position on either side of the bale. The bale is then lifted from the ground by raising the bale wrapping apparatus. The bale is rotated about its longitudinal axis by the rollers while a roll of wrapping material carried on an arm that is rotated about an axis that extends perpendicular to the bale axis swings around the ends of the bale so as to wrap the entire bale in the wrapping material. When the wrapping process is complete, the bale wrapping apparatus is lowered to bring the bale into contact with the ground and the tractor reversed to disengage the bale. Thus the wrapping process involves a backwards and forwards shuttling motion of the tractor.

EP0 565 055 discloses a bale wrapping apparatus that is fitted to the front end of a tractor directly in front of the vehicle. The bale wrapping apparatus comprises a generally U-shaped frame, which has a pressing device fitted to the forward (furthest from the tractor) arm of the frame and a belt arrangement fitted to the rearward (closest to the tractor) arm of the frame. A cylindrical bale is engaged by lowering the bale wrapping apparatus over the bale so that the bale is disposed between the two arms of the U-shaped frame. In this position, the belt is contact with one lengthways extending side of the bale. The pressing device is then operated to bring it into contact with another, generally opposite, lengthways extending side of the bale to press the bale against the belt. The U-shaped frame is then rotated through 90° to bring the belt carrying arm into a horizontal position in which it is below the bale so that the bale is supported on the belt. The bale is then rotated about its axis by operation of the belt, while a roll of wrapping material is rotated about an axis perpendicular to the bale axis to swing around the ends of the bale and so wrap then entire bale in the wrapping material. Once the wrapping process is completed, the U-shaped frame is rotated back through 90° to present the open end of the frame to the ground and allow the bale to be deposited on the ground. Once the bale is on the ground, the pressing device is retracted and raising the U-shaped frame clear of the bale allows the tractor to reverse and clear the bale. Thus the wrapping process involves a backwards and forwards shuttling motion of the tractor coupled with stopping the tractor while the bale is picked up and later deposited on the ground.

### SUMMARY OF THE INVENTION

The invention provides a bale wrapping apparatus comprising a bale engager to engage an end of a bale and a bale engager mover to move the bale engager between a bale engaging position in which said bale engager faces in a first direction and a bale releasing position in which said bale engager faces in a second direction such that a said bale can be engaged and disengaged by said bale engager while said bale engaging apparatus is propelled in one direction.

The invention also includes a method of wrapping a bale having a longitudinal axis, said method comprising providing a bale wrapping apparatus having a bale engager and a bale engager mover that is operable to move said bale engager, disposing said bale engager in a bale engaging position in which it faces in a first direction, propelling said bale engager in said first direction to engage an end of a said bale, moving said bale engager to a bale releasing position in which said bale engager faces in a second direction and propelling said bale engager in said first direction to release said bale from said bale engager.

The invention also includes a bale wrapping apparatus comprising a bale engager to engage a bale with said bale orientated such that a longitudinal axis thereof is disposed generally parallel to a ground surface on which said bale rests and a bale engager mover operable to move said bale engager to a bale wrapping position at which said longitudinal axis is disposed generally upright.

The invention also includes a bale wrapping apparatus comprising a bale engager and a bale engager mover to be mounted to a propelling vehicle such that the bale engager is disposed to one side of said propelling vehicle to permit engagement with an end of a bale disposed outside of a path along which said propelling vehicle travels when propelling said bale engager into engagement with said bale.

The invention also includes a method of wrapping a bale comprising providing a bale wrapping apparatus having a bale engager and a bale engager mover operable to move said bale engager, engaging an end of said bale by propelling said bale engager into said end, operating said bale engager mover to move said bale engager to move said bale to a position in which a longitudinal axis thereof is disposed upright and applying a wrapping material to said bale while rotating said bale engager to rotate said bale about said longitudinal axis.

The invention also includes a method of wrapping a bale comprising providing a bale wrapping apparatus having a bale engager and a bale engager mover operable to move said bale engager on a propelling vehicle, disposing said bale engager to one side of said propelling vehicle and moving said propelling vehicle along a path to bring said bale engager into engagement with a bale disposed outside of said path.

### BRIEF DESCRIPTION OF THE DRAWINGS

In order that the invention may be well understood, an embodiment thereof, which is given by way of example only, will now be described with reference to the drawings in which:

FIG. 1 is a plan view of a bale wrapping apparatus fitted to a front of a tractor;

FIG. 2 is a perspective view of the bale wrapping apparatus of FIG. 1 in a refracted condition;

FIG. 3 is a view corresponding to FIG. 2 showing the bale wrapping apparatus in an extended bale loading condition;

FIG. 4 shows the extended bale wrapping apparatus in a bale wrapping condition;

FIG. 5 shows the extended bale wrapping apparatus in a bale unloading condition;

FIG. 6 is a side elevation of an arm carrying wrapping material holders;

FIG. 7 is an enlarged plan view of a bale engager of the bale wrapping apparatus of FIG. 1;

FIG. 8 is an enlarged perspective view of an end region of the bale wrapping apparatus of FIG. 1; and

FIG. 9 is a schematic illustration of the bale wrapping apparatus of FIG. 1 in use to wrap bales disposed in a line.

### DETAILED DESCRIPTION OF THE ILLUSTRATED EMBODIMENT

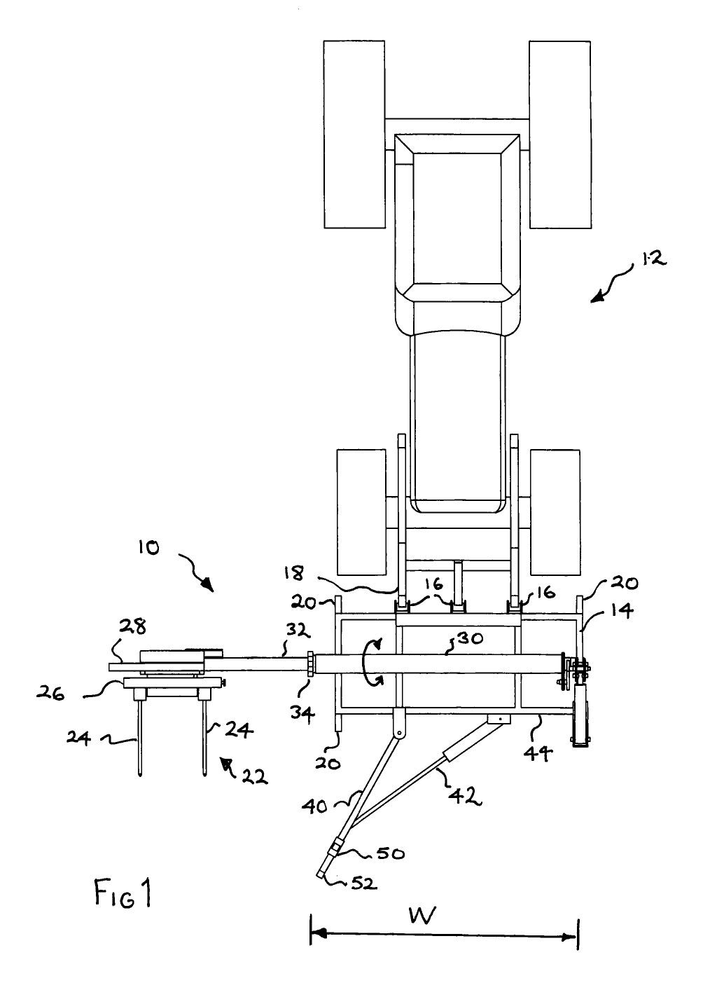

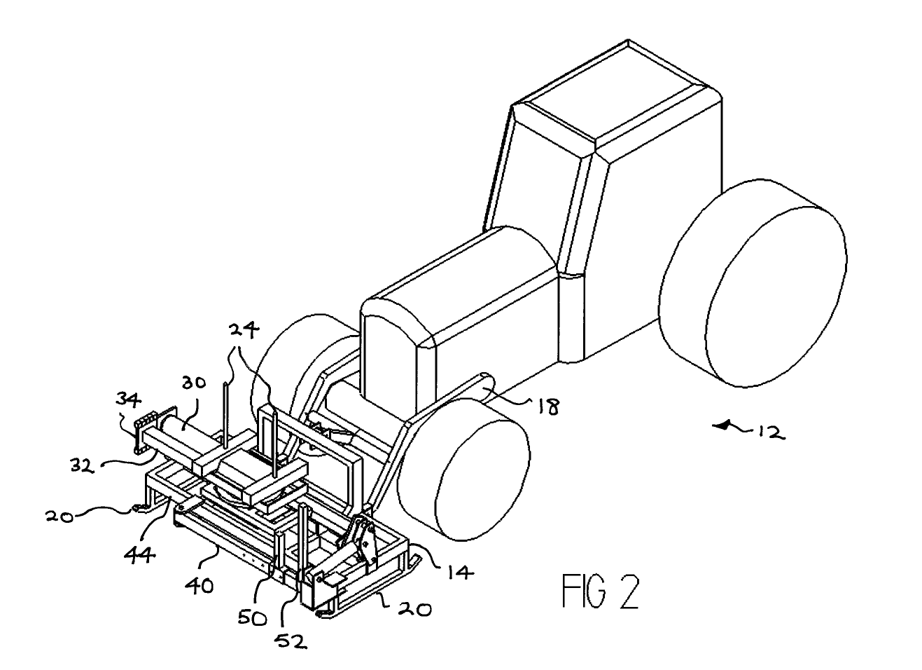

Referring to FIGS. 1 and 2, a bale wrapping apparatus 10 is shown attached to a forward end of a propelling vehicle in the form of a tractor 12.

The bale wrapping apparatus 10 comprises a support frame 14, which in the illustrated embodiment comprises a plurality of tubular members welded together to define an open rectangular structure. The support frame 14 is provided with a plurality of connection points 16 by means of which it can be releasably attached to a front linkage 18 of the tractor 12. The sides of the support frame 14 are fitted with ground engaging members, which in the illustrated embodiment take the form of respective skids 20, but could take other forms such as wheels. The skids 20 provide some support for the bale wrapping apparatus 10, which would otherwise be cantilevered from the front of the tractor 12. This can reduce the strength required of the support frame 14, connection points 16 and front linkage 18 and so permits the use of structures that are smaller and lighter. The skids can additionally provide for greater stability, thereby reducing the need to counterbalance the weight of the bale and bale wrapping apparatus and/or reducing the likelihood of tipping the tractor 12.

The bale wrapping apparatus comprises a bale engager 22 that comprises a plurality of elongate bale engaging members in the form of tines 24 that project from a turntable 26. In the illustrated embodiment there are two tines 24. However, this is not to be taken as limiting as there could be three or more tines. In principle, there could just be one tine. However, the use of one tine may require the provision of some means resisting rotation of the bale relative to the turntable during wrapping.

The turntable 26 is operable to rotate the tines 24 about an axis that extends generally parallel to their respective longitudinal axes. The turntable 26 is driven by a hydraulic motor (not visible in the drawings) that can be powered from a hydraulic pump that is a part of the tractor 12. The provision of such a hydraulic drive system on a tractor and hose connections to the hydraulic motor is something that would be familiar to the skilled person and so is omitted from the drawings to allow other features to be seen more clearly.

The turntable 26 is carried by a bale engager mover that comprises a support 28 that is provided at an end of support arm 30, 32. The turntable 26 is mounted on the support 28. The support arm comprises a first portion 30 that is mounted to the support frame 14 in bearings (not shown) such that it is fixed to the support frame but can rotate about its longitudinal axis. The support arm additionally comprises a second portion 32 that is connected to the first portion 30 by a hinge 34. The hinge 34 can be locked to secure the second portion 32 in an extended, use, position that is shown in FIG. 1. Locking can be obtained by the use of any suitable locking device such as a clamp (not shown). When the hinge 34 is released, the second portion 32 can pivot to a retracted, transportation, position that is shown in FIG. 2. When the second portion 32 is in its use position, it is aligned end-to-end with the first portion 32. When in its refracted position it is disposed in generally parallel side-by-side relation to the first portion 30 with the bale engager 22 disposed over and/or ahead of the support frame 14 and within an area having a width W defined by the respective ends of the first portion 30. In this condition, the width of the bale wrapping apparatus 10 can be reduced to a width less than, or at least not greatly exceeding, the width of the tractor 12. This facilitates transportation of the bale wrapping apparatus when not in use.

The bale wrapping apparatus 10 additionally comprises a wrapping material carrier that comprises an arm 40 pivotally connected to the support frame 14 and a hydraulic actuator 42 that is pivotally connected to both the support frame and the arm 40. The arm 40 and hydraulic actuator 42 are connected to a transverse member 44 of the support frame 14 that forms the leading end of the support frame (ie the end disposed furthest from the tractor 12) and in the illustrated embodiment are disposed substantially in the plane of the support frame. The hydraulic actuator 42 is a hydraulic ram that is operable to cause the arm 40 to pivot between an extended, use, position (shown in FIG. 1) and a retracted, transportation, position (shown in FIG. 2). When in the retracted position, the arm 40 and hydraulic actuator 42 are disposed in substantially parallel side-by-side relation with the transverse member 44 to make the apparatus compact for transportation.

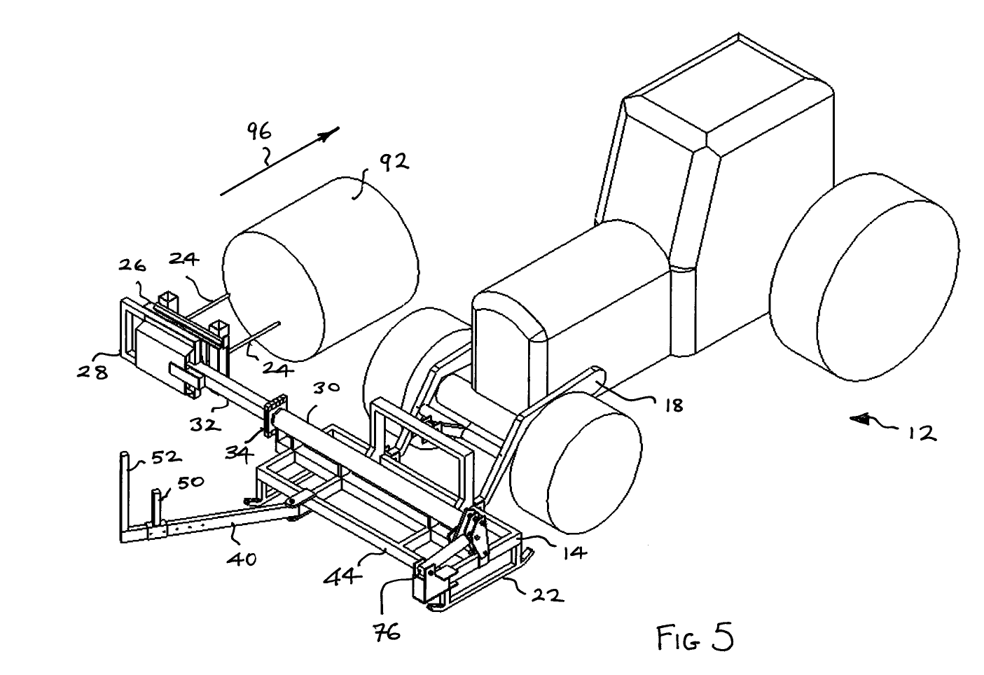

The arm 40 is provided with at least one wrapping material holder 48 (omitted from FIGS. 1 and 2 and best seen in FIG. 6). In the illustrated embodiment there are two wrapping material holders 48. The wrapping material holders 48 are mounted on respective mounting members 50, 52 that project transversely of the arm 40. Each wrapping material holder 48 comprises a mast 54 that has one end secured to the respective mount 50, 52. The masts 54 carry two aligned bearing members 56, 58 that are configured to engage the ends of a standard roll of wrapping material such that the roll can rotate about an axis of rotation defined by the bearing members. One bearing member may be spring loaded to allow for some relative movement away from the other to allow fitting of a roll of wrapping material.

The wrapping material holders 48 additionally comprise two transversely extending support arms 60, 62. The support arms 60, 62 carry two guide rollers 64, 66 that are disposed in parallel spaced apart relationship and rotate about respective axes of rotation that are parallel to the axis of rotation defined by the bearing members 56, 58. The free end of a wrapping material can be drawn from the roll on which it is carried and threaded between the guide rollers 64, 66, which guide and provide support for the film during wrapping.

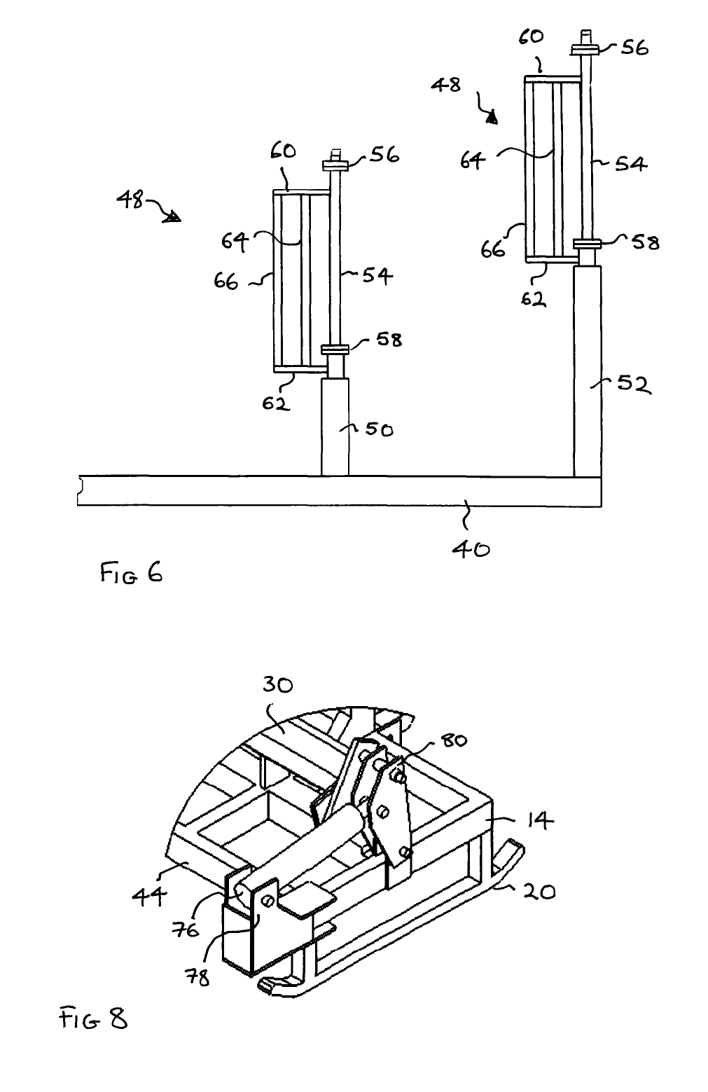

Referring to FIG. 7, a combined clamp and cutter 70 is carried by the turntable 26. The clamp and cutter 70 is carried on the end of a hydraulic actuator 72 in the form of a hydraulic ram that is mounted on a side of the turntable 26. The clamp and cutter 70 can clamp the ends of the wrapping material to the turntable 26 and be moved away from the turntable by the hydraulic actuator 72 to release the clamped ends. Subsequent rotation of the clamp and cutter 70 can cut the material and clamp the newly created ends of the wrapping material.

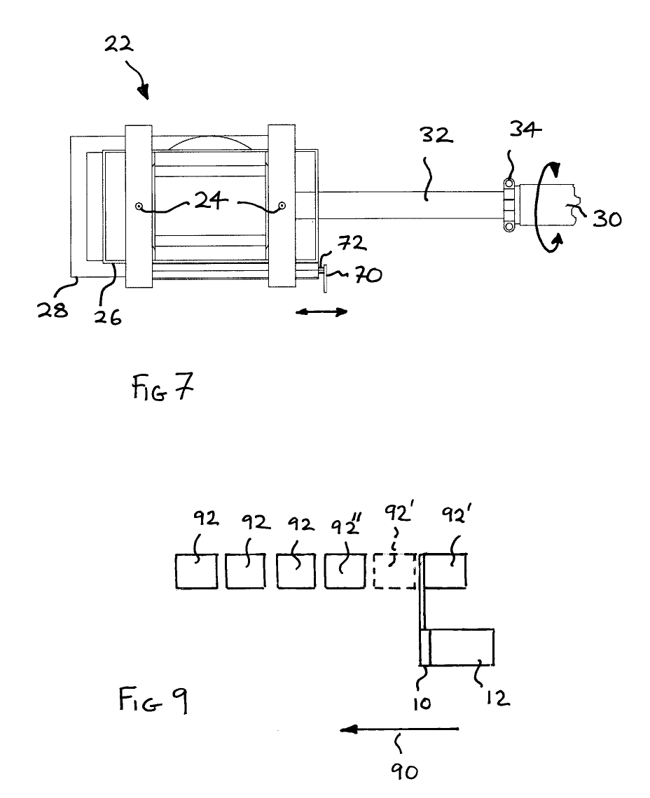

Referring to FIG. 8, a hydraulic actuator 76 for the bale engager mover is shown fitted to one side of the support frame 14. The hydraulic actuator 76 is hydraulic ram that has one end pivotally secured to the support frame 14 at 78 and the other end pivotally secured to a linkage 80 that is pivotally mounted to one side of the support frame. The linkage 80 is secured to an end of the first portion 30 of the bale engager mover support arm 30, 32 to transmit rotational movement to the support arm. As will be described in more detail below, the hydraulic actuator 76 is operable to drive the linkage to provide approximately 180° of rotational movement to the support arm 30, 32.

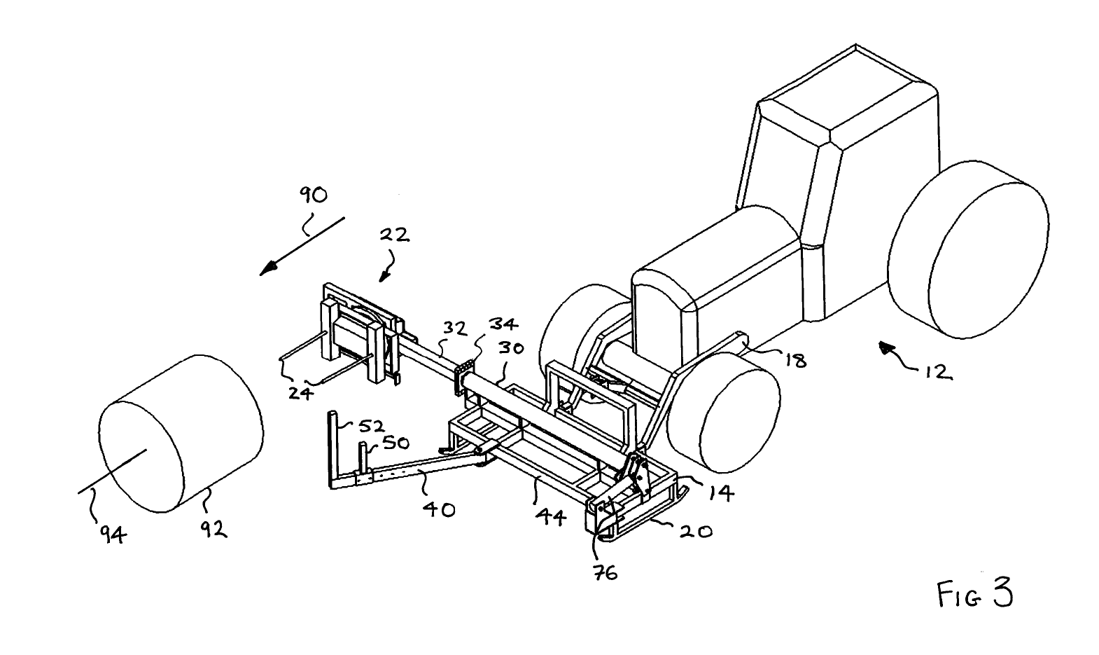

Operation of the bale wrapping apparatus 10 will now be described with reference to FIGS. 3 to 5.

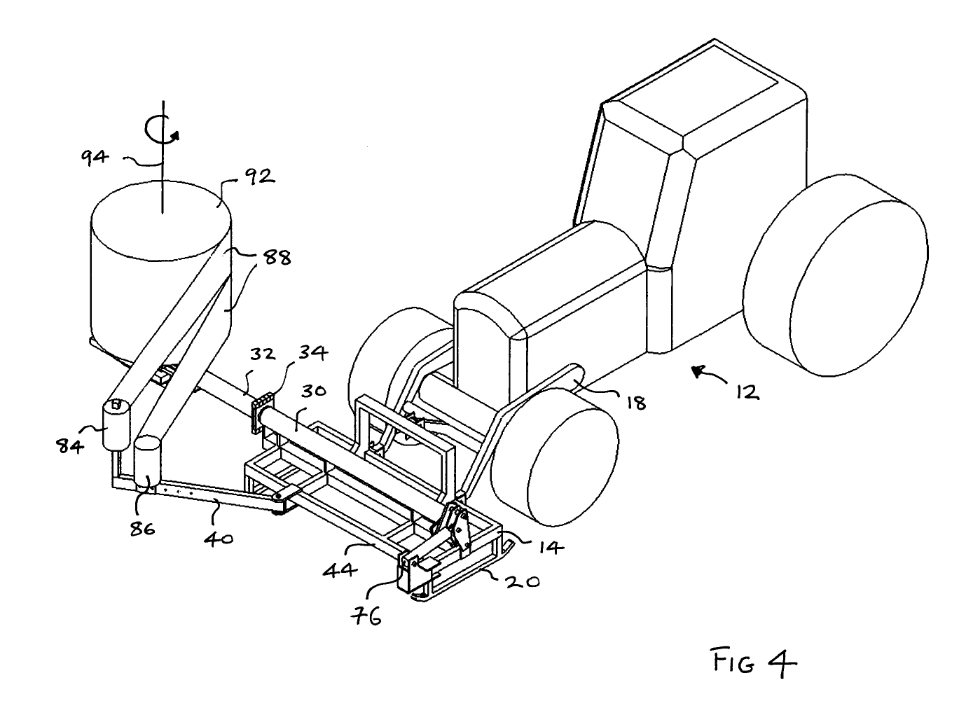

FIG. 3 shows the bale wrapping apparatus 10 in an extended bale engaging condition. The hydraulic actuator 42 (omitted from FIGS. 3 to 5) has been operated to pivot the arm 40 to a position in which it extends forwardly of the support frame 14 in a direction away from the tractor 12. The wrapping material holders 48 (not shown in FIGS. 3 and 5) are each loaded with a roll 84 of a suitable plastics wrapping material as indicated in FIG. 4. The wrapping material 88 is threaded through the guide rollers 64, 66 of the respective wrapping materials holders 48 with the end of each secured to the turntable 26 by the clamp and cutter 70. The support arm 30, 32 of the bale engager mover is in its extended, use, condition with the first second portion 32 inline with the first portion 30 and the hinge 34 locked to prevent relative movement of the two portions. The hydraulic actuator 76 has been operated to rotate the support arm 30, 32 and bring the bale engager 22 to a position in which the tines 24 extend in a first direction, which is forwardly of the tractor 12 and indicated by arrow 90. In this orientation, the plane of the turntable 26 is disposed approximately perpendicular to the ground on which the tractor 12 is operating.

In FIG. 3, the bale wrapping apparatus is shown ready to engage a bale 92. The bale is generally cylindrical and is laid on its side so that its ends are exposed and its longitudinal axis 94 is disposed generally horizontally and parallel to the ground. The respective longitudinal axes of the tines 24 are disposed generally parallel to the longitudinal axis 94 of the bale. To engage the bale 92, the driver of the tractor 12 simply moves the tractor forwards in the direction of the arrow 90 until the tines 24 are fully inserted into the facing end of the bale. As bales are formed from the centre outwards, the centre of the spiral can usually be easily seen making it relatively easy for the driver to centre the bale engager 22 with respect to the bale.

Once the tines 24 are fully engaged, the hydraulic actuator 76 is operated to cause the support arm 30, 32 to rotate and turn the bale engager 22 through approximately 90° to bring the bale 92 to the position shown in FIG. 4. In this position, the longitudinal axis 94 of the bale 92, the respective longitudinal axes of the tines 24 and the axis of rotation of the turntable 26 are all disposed upright and approximately perpendicular to the ground. The axis of rotation of the turntable 26 and the longitudinal axis 94 of the bale 92 are preferably in line.

With the bale engager in the position shown in FIG. 4, the hydraulic motor that drives the turntable 26 is operated to cause the turntable to rotate (anticlockwise in the drawing). Because the respective ends of the wrapping material 88 are held by the clamp and cutter 70, the wrapping material is drawn from the rolls 84, 86 and wrapped around the periphery of the bale 92 as the turntable rotates. Once the driver judges that the bale 92 is sufficiently covered, the turntable 26 is stopped and the hydraulic actuator 72 is operated to move the clamp and cutter 70 away from the turntable 26 to release the ends of the wrapping material.

With the clamp and cutter 70 maintained in its extended condition, the hydraulic actuator 76 is operated to rotate the bale engager 22 through approximately 90° to bring it to the position shown in FIG. 5. In this position, the bale engager 22 faces in a second direction, indicated by the arrow 96, that is approximately opposite the first direction, indicated by the arrow 90 in FIG. 3. Thus, instead of being ahead of the bale wrapping apparatus as in FIG. 3, the bale is now behind the apparatus. The hydraulic actuator 72 is then operated to retract the combined cutter clamp 70, which simultaneously cuts through the wrapping material 88 to free the material wrapped around the bale 92 and clamps the newly created ends of the wrapping material 88 to the turntable 26. The tractor 12 can then be driven forwards in the first direction 90 to unload/disengage the bale 92. This completes a bale wrapping operation.

Once a bale wrapping operation is complete, the hydraulic actuator 76 can be operated to turn the support arm 30, 32 back through approximately 180° to return the bale engager 22 to the position shown in FIG. 3 to ready the bale wrapping apparatus 10 for a bale wrapping operation on another bale.

FIG. 9 shows schematically how the bale wrapping apparatus can be used to sequentially wrap bales that are disposed in line by driving alongside the line of bales in a continuous forward motion. Using the bale wrapping process described above with reference to FIGS. 3 to 5, the bale wrapping apparatus 10 has engaged the first bale 92′ of a line of bales 92 and wrapped it with a suitable wrapping material. The FIG. 3 starting position of the bale 92′ is indicated in dashed lines and the finish position of FIG. 5 is shown in solid lines. It can be seen that the bale 92′ has been flipped through approximately 180° so that it is behind the bale wrapping apparatus 10. This leaves the space previously occupied by the bale 92′ empty, allowing the bale wrapping apparatus 10 to be propelled in the direction of the arrow 90 to engage the next bale 92″ in the line of bales. On completion of a bale wrapping operation on the bale 92″, the bale 92″ will be located approximately in the space previously occupied by the bale 92′, leaving the space it previously occupied clear for the bale wrapping apparatus 10 to be propelled in the direction of the arrow 90 to engage the next bale in the line. In this way, the bale wrapping apparatus 10 can be propelled relatively speedily along a line of bales, wrapping each sequentially and leaving the wrapped bales in a line that is shifted roughly one bale's length in the lengthways thereof from its starting position.

Thus, the bale wrapping apparatus allows a simple bale wrapping procedure that can be carried out without the driver needing to dismount from the propelling vehicle. Furthermore, the motion of the tractor need only be a forward motion and since the bale is disposed to one side of the vehicle during the engaging, wrapping and unloading processes the driver has good visibility of the operation and does not suffer the inconvenience of having to turn in his/her seat.

The bale wrapping apparatus permits a relatively simple low cost design, which does not require a complicated control system and/or sensors. Since the driver of the propelling vehicle has good visibility of the operation, it is possible to provide a control system simply comprising switches for the hydraulic actuators. Optionally, a counter that records the number of bales that have been wrapped may be provided.

The bale engager may comprise simple tines, or similar such elongate members, that are inserted into the end of the bale to hold the bale relative to the bale engager during a wrapping operation. During bale engagement and bale release the periphery of the bale is in contact with the ground and so be held due to friction while the bale engager is moved to insert or withdraw the tines. During wrapping, the bale will be held on the bale engager by a combination of gravity and the insertion of the tines in the bale.

In the illustrated embodiment the hydraulic actuators are powered by the tractor's onboard hydraulic drive system. It is to be understood that this is not essential. The bale wrapping apparatus could be provided with an independent hydraulic drive system to supply hydraulic power to the hydraulic actuators. In that case, the hydraulic drive system could be powered from the tractor's electrical supply system. In principle, the electrically powered actuators could be used in place of hydraulic actuators powered from the tractor's electrical supply system.

The illustrated embodiment is described as being mounted to the front linkage of a tractor. This is not essential. The bale wrapping apparatus may be configured to be mounted to the rear hitch of a tractor. It will also be understood that the bale wrapping apparatus is not limited to use with a tractor as the propelling vehicle and may be mounted to any suitable and/or desired vehicle. The bale wrapping apparatus may alternatively be an integral part of a self-propelling vehicle.

It is preferable that the bale wrapping apparatus is mounted on the propelling vehicle such that the bale wrapping operation is easily visible from the normal driving position. However, in cases in which the bale wrapping apparatus is mounted such that the driver has to turn in their seat to view the bale wrapping operation, there is still the advantage of having only to drive the vehicle in a relatively straight line in one direction.

In trial runs, an embodiment of the bale wrapping apparatus has proved capable of wrapping one hundred 4.5 foot (1.35 m) bales per hour using approximately 1.1 rolls of wrapping material (ie approximately 90 bales can be wrapped using just 1.0 roll of wrapping material). By way of comparison, known bale wrapping apparatus can typically wrap just twenty four similar size bales per hour using approximately 1.0 rolls of wrapping material.

1. A bale wrapping apparatus to wrap a bale that has a first end and a second end disposed opposite said first end, said bale wrapping apparatus comprising:
a bale engager comprising at least one elongate bale engaging member to be inserted in said first end of said bale; and
a bale engager mover to move the bale engager,
wherein said bale engager mover is operable to move said bale engager between a bale engaging position in which said bale engager faces in a first direction to permit said at least one elongate bale engaging member to be inserted in said first end and a bale releasing position in which said bale engager faces in a second direction such that a said bale can be engaged and disengaged by said bale engager while said bale engaging apparatus is propelled in one direction, and
wherein said second end of said bale is disposed forwardly of said first end when said bale engager faces in said first direction and said at least one elongate bale en a in member is inserted into said first end and rearwardly of said first end when said bale engager is in said bale releasing position.

2. A bale wrapping apparatus as claimed in claim 1, wherein said second direction is substantially opposite said first direction.

3. A bale wrapping apparatus as claimed in claim 1, wherein said bale engager mover is able to rotate said bale engager through an angle greater than 90° to move said bale engager between said bale engaging and bale releasing positions.

4. A bale wrapping apparatus as claimed in claim 1, wherein said bale engager mover is operable to move said bale engager to a bale wrapping position that is intermediate said bale engaging and bale releasing positions in which a longitudinal axis of said bale engaged by said bale engager is disposed in a generally upright condition.

5. A bale wrapping apparatus as claimed in claim 4, wherein said bale engager comprises a rotary actuator so that said bale carried by said bale engager can be rotated about said longitudinal axis when said bale engager is in said bale wrapping position.

6. A bale wrapping apparatus as claimed in claim 4, wherein said at least one bale engaging member is disposed generally horizontally when said bale engager is in said bale engaging and releasing positions.

7. A bale wrapping apparatus as claimed in claim 6, wherein said at least one bale engaging member is disposed generally upright when said bale engager is in said bale wrapping position.

8. A bale wrapping apparatus as claimed in claim 1, wherein said bale engager mover comprises an elongate arm that is rotatable about a longitudinal axis thereof to move said bale engager between said bale engaging and bale releasing positions, said elongate arm comprising a first portion fixed to a support frame and a second portion connected with said first portion and movable relative thereto between an extended, use, position and a retracted, transportation, position in which said bale engager is disposed within an area having a width defined by respective ends of said first portion.

9. A bale wrapping apparatus as claimed in claim 1 wherein in use said bale engager is disposed to one side of a propelling vehicle with which said bale engager is connected.

10. A bale wrapping apparatus as claimed in claim 1, comprising at least one bale wrapping material carrier that is movable between an extended use position and a retracted transportation position.

11. A bale wrapping apparatus as claimed in claim 1, comprising a device to secure an end of a wrapping material to said bale engager.

12. A method of wrapping a bale having a longitudinal axis, a first end and a second end disposed opposite said first end, said method comprising:
providing a bale wrapping apparatus having a bale engager comprising at least one elongate bale engaging member to be inserted in said first end of said bale and a bale engager mover that is operable to move said bale engager;
disposing said bale engager in a bale engaging position in which it faces in a first direction;
propelling said bale engager in said first direction to insert said at least one elongate bale engaging member in said first end of said bale;
moving said bale engager to a bale releasing position in which said bale engager faces in a second direction and said bale has been moved from a position in which said second end is disposed forwardly of said first end to a position in which said second end is disposed rearwardly of said first end; and
propelling said bale engager in said first direction to release said bale from said bale engager.

13. A method as claimed in claim 12, wherein said propelling of said bale engager in said first direction moves said bale engager along a line substantially in line with said longitudinal axis of said bale.

14. A method as claimed in claim 12, wherein said bale is in a ground engaging position when said bale engager is in said bale engaging and bale releasing positions.

15. A method as claimed in claim 12, comprising moving said bale engager to a bale wrapping position intermediate said bale engaging and bale releasing positions, rotating said bale around said longitudinal axis and applying wrapping material to said rotating bale.

16. A method as claimed in claim 15, wherein an end of said material is secured to said bale engager so as to be rotatable with said bale and comprising operating an actuator to release said secured end and separate wrapping material applied to said bale from a supply of said wrapping material carried by said bale wrapping apparatus.

17. A method as claimed in claim 16, comprising operating said actuator to cause said separation of said wrapping material applied to said bale when said bale engager has moved at least to a position intermediate said bale wrapping and bale releasing positions, said operation of said actuator causing ends of said supply of material created by said separation to be secured to said turntable.

18. A method as claimed in claim 12, wherein following release of said bale from said bale engager said bale engager is propelled in said first direction to engage a first end of a second said bale that is disposed generally in line with said bale.

19. A method as claimed in claim 12, comprising mounting said bale wrapping apparatus to an end of a propelling vehicle with said bale engager disposed to one side of said vehicle.

20. A bale wrapping apparatus to wrap a bale having a first end, a second end and a longitudinal axis extending between said first and second ends, said bale wrapping apparatus comprising:
a bale engager comprising a plurality of elongate engaging members to be inserted into said first end of said bale with said bale orientated such that said longitudinal axis is disposed generally parallel to a ground surface on which said bale rests;
a bale engager mover operable to move said bale engager to a bale wrapping position at which said longitudinal axis is disposed generally upright; and
a rotary actuator operable to cause rotation of said bale carried by said bale engager when in said bale wrapping position about said longitudinal axis,
wherein said bale engager mover is operable to move said bale engager through substantially 90° to move said bale engager from said bale engaging position to said bale wrapping position and through substantially a further 90° from said bale wrapping position to a bale releasing position.

21. (canceled)

22. A bale wrapping apparatus as claimed in claim 20, wherein said bale engager is carried by said bale engager mover such that in use said bale engager is disposed to one side of a propelling vehicle with which said bale engaging apparatus is connected.

23. (canceled)

24. A bale wrapping apparatus as claimed in claim 20, further comprising a support for said bale engager and bale engager mover, said support to be mounted to an end of said propelling vehicle such that said bale engager is spaced from said propelling vehicle in a both a lengthways and a transverse direction of said propelling vehicle.

25. (canceled)

26. A bale wrapping apparatus as claimed in claim 20, wherein said rotary actuator is operable to rotate said bale to draw a wrapping material having an end secured to said bale engager around said bale.

27. (canceled)

28. A method of wrapping a bale having a first end, a second ends disposed opposite said first end and a longitudinal axis extending between said first and second ends, said method comprising:
providing a bale wrapping apparatus having a bale engager and a bale engager mover operable to move said bale engager;
engaging an elongate bale engaging member of said bale engager in said first end of said bale by propelling said bale engager in a first direction to insert said elongate bale engaging member into said end;
operating said bale engager mover to move said bale engager through substantially 90° to move said bale to a position in which said longitudinal axis is disposed upright and applying a wrapping material to said bale while rotating said bale engager to rotate said bale about said longitudinal axis; and
operating said bale engager mover to move said bale engager through substantially a further 90° to a bale releasing position.

29. (canceled)
